(19) United States
(12) Patent Application Publication
(10) Pub. No.: US 2009/0264100 A1
(43) Pub. Date: Oct. 22, 2009

(54) Flexible Messaging System For Mobile Phone Users

(75) Inventors: Yehoshua Sapir, Tel- Aviv (IL); Bezalel Finkelstein, Petach Tikva (IL); Oren Aviram, Petach Tikva (IL); Shay Horovitz, Rishon Lezion (IL)

Correspondence Address: The Law Office of Michael E. Kondoudis, 888 16th Street, N.W., Suite 800, Washington, DC, 20006, US

(73) Assignee: CELL 2 NET (ISREAL) LTD, Tel Aviv (IL)

(21) Appl. No.: 12/301,615

(22) PCT Filed: May 21, 2007
(86) PCT No.: PCT/IL07/00613

§ 371 Date: Nov. 19, 2008

Related U.S. Application Data
(60) Provisional application No. 60/802,288, filed on May 22, 2006.

(51) Int. Cl. H04M 1/66; H04M 3/42

(52) U.S. Cl. 455/411; 455/412.2

(57) ABSTRACT

The present invention is a system and a method for managing messages that are designated to a user's mobile communication device, using at least one internet messaging service. According to some embodiments of the invention, the system may comprise a user's device; at least one database; a managing server; and a distributor. Upon identification of a new message the managing server may send the details of the designated user to the distributor, and consequentially, the distributor may initiate a call to the user's device to notify the user regarding the arrival of the new message, using said user's details. Upon receiving the notification the user may enter a messaging service site (managed by the managing server) to view the message.

### FIELD OF THE INVENTION

The present invention generally relates to the field of messaging systems. More particularly, the present invention relates to the field of messaging systems, for mobile communication networking.

### BACKGROUND OF THE INVENTION

Many mobile communication users use messaging services such as Short Messaging Service (SMS), Multimedia Messages Service (MMS) and the like. Users are quite used to writing SMS text messages, for instance, on daily or even hourly basis, using the mobile device's reduced keypads. The problem is that users are forced to pay for each message they send, usually to the mobile communication supplier such as cellular companies and operators and since these companies own these services, they control the charging rates per message.

Many mobile communication devices allow connecting to the internet using, for example Wireless Application Protocol (WAP) and surfing at least some of the pages available to viewing by mobile devices such as, for example, cellular phones, Personal Digital Assistant (PDA) and the like.

To send and receive messages, using a mobile device without having to use the suppliers' messaging services such as the SMS or MMS, a user may send and receive emails through the internet, using the WAP applications already existing in most mobile devices to connect to the internet. Once connected to the internet, the user may be able to use messaging services available on the internet such as, emailing services, Voice over Internet Protocol (VoIP) services as well as many other internet services known in the art.

Although many systems available today allow surfing the internet using mobile devices, these systems do not allow receiving messages' notifications directly to the user's mobile. device. To check whether the user has a new message or messages, the user is obliged to enter his mailbox, for example, and view his messages. For this reason, many users still prefer using the regular messaging services offered by the mobile communication companies—in order to be notified when a new message has arrived.

To solve this issue a service known as HOTEXT, which is a messages service that uses the internet, rather than the Short Message Service (SMS) is offered. This messaging service aims to be cheaper than the available services. According to the HOTEXT service, the users have to download a java application to their mobile phone to use the service. Once the java application is installed in the mobile device, it enables receiving notifications and messages through the internet directly to the mobile device.

The HOTEXT service obliges the user to download and install a java application to his/her mobile device in order to be able to use this service. This may limit the system and its service, since for each new mobile device and/or a new version of the application the users may be obliged to reload and reinstall the application.

Other disadvantages to the HOTEXT service are that it does not offer applications that allow the use of cheaper communication such as VoIP; it does not allow “viral distributing” of messages to invite new users—which is the ability to allow the users to invite other users to join the service through emails, for example. Since the HOTEXT service requires application installation, the system cannot invite another user who does not have the application installed, to join the service unless the user installs the application.

### SUMMARY OF THE INVENTION

The present invention is a novel system and a method for managing of messaging services for mobile communication devices that use wireless communication networks, without the necessity to install a software application at the users' mobile communication devices.

According to some embodiments of the present invention, the system may comprise a user's mobile device - shortly referred to as “user's device” in this document; a managing server; a database; and a distributor, which may be an operator, a server or both.

The managing server may provide services for standard wireless communication based devices such as, for example, cellular phones, pagers and other mobile handheld devices - with access to email and messages-based Web pages such as, for example text-based pages. A commonly used server that may provide these utilities is a Wireless Application Protocol (WAP) server accessing internet based sites through WAP protocols.

According to some embodiments of the present invention, the system may comprise: a user's device; at least one database that comprises the users' personal messages, the messages' related information and the user's personal details; a managing server that enables identifying the arrival of a new message, retrieving of the new message and the details of the user to whom the new message is designated to- from the database; and a distributor that enables notifying the user regarding the arrival of said new message, upon receiving the user's details from the managing server. Upon identification of a new message the managing server may send the distributor the details of the user to whom the message is designated, and consequentially, the distributor may initiate a call to the user's device to notify the user regarding the arrival of the new message, using said user's details.

According to some embodiments of the present invention, the distributor's call to the user's device may be identified by the user's device and stored under a name that is associated with the identified number of the distributor.

Alternatively, the distributor's call to the user's device may be identified by the user's device as a confidential number.

According to embodiments of the invention, notifying the user may be carried out by causing the user's device to ring (hence calling the device). The distributor may be preset to ring the user's device for a preset time-interval, once a ringing tone is achieved, to facilitate in preventing the user from answering the notification call. In this way the user's device may ring once, for example, to notify the user regarding the arrival of a new message.

Additionally the system may enable inviting other new users to join the messaging service. Once a veteran user sends a message to a new user unknown to the system—the system may automatically send an invitation message to the new user's device. The invitation message may be an SMS message, for example containing a link to the messaging service site to allow the new user to register through the site.

### BRIEF DESCRIPTIONS OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 is a schematic illustration of a system for messaging, according to some embodiments of the present invention.

FIG. 2 is a flowchart that schematically illustrates a method for messages notification, according to some embodiments of the present invention.

FIG. 3 is a schematic illustration of a process for inviting a new user, according to some embodiments of the present invention.

The drawings together with the description make apparent to those skilled in the art how the invention may be embodied in practice.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

### DETAILED DESCRIPTIONS OF SOME EMBODIMENTS OF THE INVENTION

The present invention is a system and a method for managing messages and notifications regarding arriving new messages that are designated to a user's mobile device 10, using at least one internet messaging or mail service.

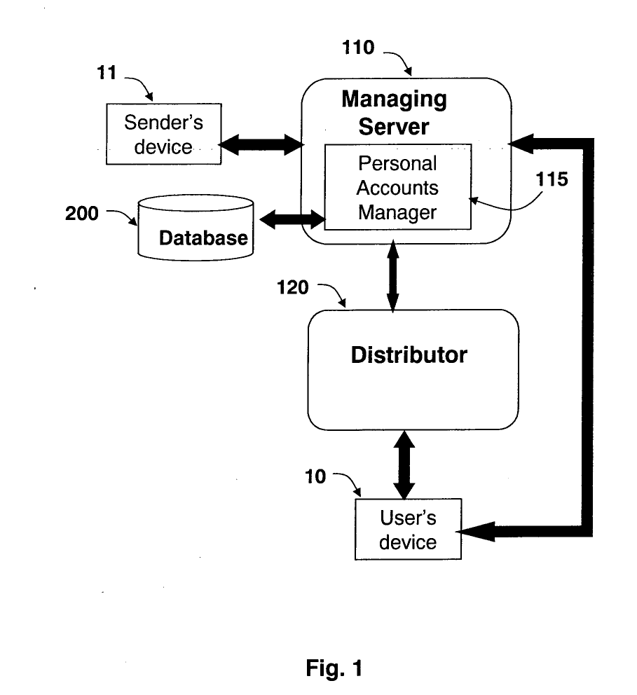

FIG. 1 schematically illustrates the system. According to some embodiments of the present invention. The system may comprise:

a user's device 10—which may be a wireless mobile communication device such as, for example, a mobile phone, a pager, a PDA and the like;

at least one database 200 that may comprise the users' personal messages, the messages' related information and the user's personal details;

a managing server 110 such as, for example, a WAP server that may enable identifying the arrival of a new message, retrieving of the new message, the new message's related data and the details of the user to whom the new message is designated. The managing server 110 may retrieve and store all this information from the database 200;

a distributor 120 that enables notifying the user regarding the arrival of the new message, upon receiving the user's details from the managing server 110.

The distributor 120 may be a cellular operator that allows calling the user's device 10 upon receiving the messaging-data and the user's details from the managing server 110 in order to notify the designated user regarding the arrival of a new message.

The distributor 120 may use the user's details—sent by the managing server 110 once a new message designated to the user has arrived—in order to initiate a notification call to the user's device 10.

According to embodiments of the present invention, the managing server 110 may maintain a website for messages service that allows presentation and operation, where this site is defined herein as a “messaging service site” such as, for example an emailing service site.

Additionally, the managing server 110 may comprise a personal accounts manager 115. The personal accounts manager 115 may enable retrieving, storing, transmitting and presenting of the users' related data and messaging-data in personal accounts that are ascribed to the users. For example, the personal accounts manager 115 may enable storing and deleting of the user's messages, allowing the user to sort his/her messages according to predetermined sorting conditions, retrieving and presenting a list of messages from the database 200, accessing the user's account and the like.

The messages may be any type of messages and in any kind of format known in the art such as, for example, text messages, an image, a video file a combination of at least some of the formats and the like. The size of the messages (in KB or in length) may be pre-limited or preset in the system.

According to embodiments of the present invention, a message may be sent to a user's device 10 by, for example a sender, using a sender's device 11. The sender's device 11 may be any device that allows entering the messaging service site composing of a message and sending that message to the managing server - for example, a computer, a Personal Digital Assistant (PDA), a mobile phone and the like.

While the description below contains many specifications, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

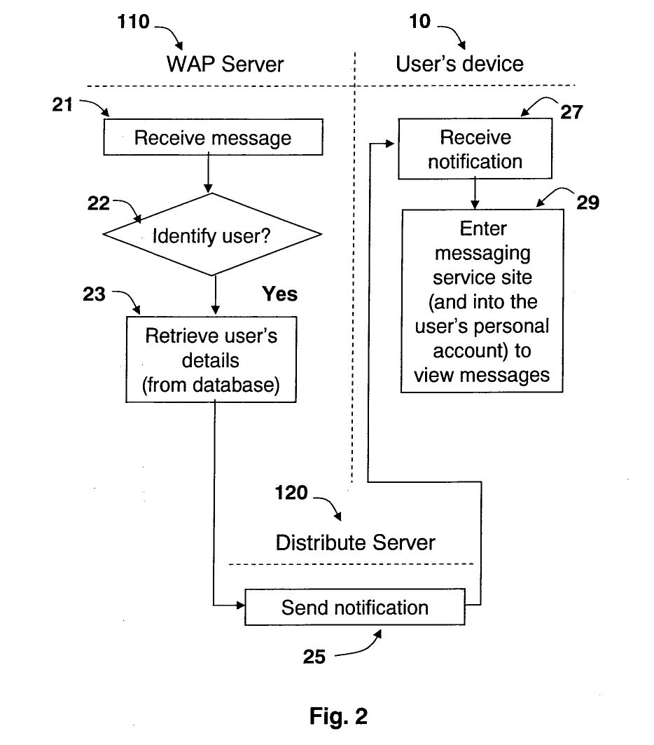

FIG. 2 is a flowchart that schematically illustrates a method for managing of messages and notifying of the user regarding the arrival of a new message, through the user's device 10, according to some embodiments of the present invention. The method may comprise the steps of:

receiving a message and messaging-data 21—where the managing server 110 may receive a new message and identify the designated user;

retrieving the user's details and the message-data 23 from the database 200—wherein upon identifying the designated user—the managing server 110 may retrieve details of the user's device 10 and other information that may facilitate in contacting and/or notifying the user's device 10 and transmitting these details to the distributor 120;

notifying the user, wherein once the details of the user's device 10 (sent by the managing server 110 upon identifying a new message designated to the user) are received by the distributor 120—the distributor 120 may send a notification 25 to the user by initiating a call to the user's device 10;

receiving the notification 27, where the user's device 10 may operate a notification signaling upon receiving the notification such as, for example, a ringing tone;

entering the messaging service site 29—where once the user has been notified regarding the arrival of a new message, the user may enter the internet through the user's device 10 into the user's personal messages account to view the new messages.

According to embodiments of the present invention, the distributor 120 may be an operator or a web server that enables calling the user by dialing the user's device 10 phone number, for example. The user's device 10 phone number may be included in the user's details.

Additionally, the call made by the distributor 120 may be identified by the user's device 10—allowing the user to save the identification number of the distributor 120 in the user's “buddy” list—meaning the list of the phone-numbers of known sources and their associate sources' names. Since the user may identify the distributor 120 calls—the user may set his/her device 10 to produce a unique ringing sound whenever the distributor 120 calls—a function many of the currently used mobile phones are capable of allowing.

Additionally, the distributor 120 may be preset to ring the user's device 10 for a preset time-interval, once a ringing tone is achieved, to prevent the user from answering the call. This way the user may only hear a short ring to notify him/her regarding the arrival of a new message. According to this embodiment - the distributor 120 may prevent the provider of this service from paying for the notification call.

The distributor 120 may enable the user's device 10 to identify a single number associated with the distributor 120 and consequently with the provider of this service. Alternatively, the distributor 120 may call the user's device 10 under a confidential number preventing the user's device 10 from identifying the caller.

To allow the distributor's 120 number to be identified by the user's device 10, the distributor 120 may use a regular or a Voice over Internet Protocol (VoIP) Private Branch Exchanges (PBX).

According to embodiments in which a VoIP PBX is used by the distributor 120 to call the users' devices 10—the distributor 120 may use spoofing techniques in order to associate the same number to the outgoing calls. The spoofing techniques may include, for example, detecting tone variations, or use modem modules that enable identifying the line's statuses.

Additionally or alternatively, the user may name the distributor 120 according to any chosen name when saving the distributor 120 number and name in the user's buddy-list. Therefore, the user may name the distributor 120 according to a notification message such as, for example: “you have a new message” or according to the name of the provider of this service such as, for example. “Cell2Net”.

According to some embodiments of the present invention, the system may reach new users through “viral distributing” mechanisms that allow already subscribed users (defined herein as “veteran users”) to invite new users through the messaging service site. Additionally or alternatively, the system may identify a potential new user when a veteran user send a message to an unknown new user through the messaging service site and automatically send an invitation message to the new user inviting the new user to join the messaging service.

According to embodiments of the present invention, the system may invite other new users to join the messaging service, once a veteran user sends a message to a new user unknown to the system. The system may automatically send an invitation message to the new user's device 10. Additionally or alternatively, the veteran user may initiate the registration of a new user by filling up the new user's details in the messaging service site.

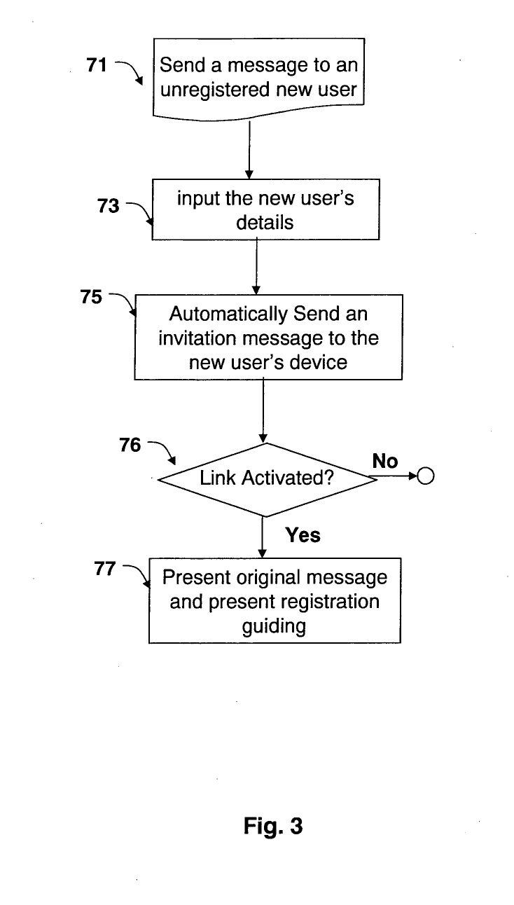

FIG. 3 schematically illustrates the process of viral distribution, according to some embodiments of the present invention. The process may comprise at least some of the following steps:

sending a new message to a new user unregistered in the system 71—where the veteran user may send the new message using his/her users' device 10 through the messaging service site;

inputting the new user's details and an invitation message 73—where the user may input, for example, the new user's name and mobile phone number and a text message that may specify the inviter's identity and the like when sending the new message;

automatically sending an invitation message to the new user's device 74—where the system may automatically send a predefined message, the inviter's message or both to the new user's device 10, using the new user's details inputted by the inviter.

According to some embodiments of the invention, invitation message may be sent to the new user's device 10 using SMS services as a text message. Additionally or alternatively, the notification message may be accompanied with a link 75 (e.g. a URL address of the messaging service site) that may allow the new user to directly reach the registration page of the site or that may automatically present the invitation message 76 along with guiding regarding the messaging services.

Additionally or alternatively, upon pressing link the new user may operate an automatic registration to the messaging service and may automatically be enlisted to this service, without having to operate any other function.

Alternatively, for user's devices 10 that do not enable executing links through SMS messages or the likes—the new user may copy the link specified in the invitation message, enter the internet on the mobile device or any other device and register to the service from the messaging service site.

According to some embodiments of the present invention, the messaging service site may allow the user to select favorite accompanying services out of predefined available services such as, for example: (1) setting the number of new messages that need to arrive to trigger the notification; (2) setting availability parameters—as to when the users chooses to be available to receive notifications during the day etc.

According to some embodiments of the present invention, the distributor 120 may be a distributed server, which may be a part of a multiplicity of desktop clients, where each client may utilize at least one call-completion line. Incorporated and coordinated servers may facilitate distributor 120 in sharing some of the workload of the central distributor 120.

According to some embodiments of the present invention, the system may allow the users to download and install a desktop client application to the users' personal computers (PC), laptops or other computerized systems. The client application may communicate with the managing server 110 and/or distributor 120.

The client application may facilitate a number of processes and functions. For example, the client application may allow the user to view at least some of his/her PC information or functions, where entering the user's PC through the user's device 10 may be carried out under security conditions according to the system's definitions and the user's choices.

Additionally or alternatively, the client application may facilitate in managing of sharing features of the system such as, for example, sharing of media file (e.g. music files), security arrangements (e.g. login data), email pushing, downloading the buddy list from the user's device 10 card (e.g. subscriber identity module (SIM) card) and the like.

Alternatively or additionally to the client application a web application may be available to facilitate substantially the same features. The web application, which may be a website, may enable users to access the system through the internet, without the need to download a client application.

According to embodiments of the present invention, the system may enable storing a substantially large number of messages per user, especially compared to the number of messages that may be stored in the user's device 10 memory.

According to some embodiments of the present invention, the system may require following some security actions prior to receiving a message—to avoid spam mail or messages, for example. The security actions may be, for example, (1) blocking the messages sent to certain senders and/or senders devices 11; (2) allowing receiving messages only from a predefined list of authorized senders and/or senders' devices 11; (3) requiring a “hand-shake” procedure prior to accepting the message such as viewing the sender's name prior to opening the message; and the like.

According to embodiments of the present invention, the user may login his personal account in the WAP page—using security means such as a login name and a password that may be required in order to view the messages or other information presented in the user's personal account.

According to some embodiments of the present invention, the system may enable presence management. Since the managing server 110 may be able to detect the users that read their messages online - using their devices 10—the system may use this indication to allow other users to view the user's that are currently online. The system may present the user only with the users that are on his/her buddy list at the user's account and that are currently using the site.

According to some embodiments of the present invention, additionally or alternatively to calling the user's device 10 in order to notify the user regarding the arrival of a new message—the system may send WAP push messages via SMS messages to execute a notification. WAP push messages are SMS messages that alert the user and may require opening of a URL address by using a link in the SMS message, for example.

If the WAP push messages is used additionally to the notification calls—the WAP push mechanism may be used for special cases predefined in the system such as, for example, only to notify the user regarding a number of new messages in his/her account, to notify the user regarding an urgent new message etc.

Some of the new generation user's devices 10 enable polling network pages called “polling scripts” using specially installed applications. This means that the network connection is open and that the page is constantly active. In user's devices 10 that allow this technology, the system may allow directly operating the device 10 to produce the notification upon identifying the new message on line without using the distributor 120. In this embodiment the distributor 120 may be replaced with the polling application where the managing server 110 may manage the user's incoming messages and the polling application may execute a notification upon the identification.

According to embodiments of the present invention, the notification may be carried out by activating the user's device 10 execute a ringing, where the polling application may manipulate the user's device 10 to allow the execution of the ringing of the device 10.

Additionally or alternatively, the notification may be carried out by activating the user's device 10 execute an SMS message, where the polling application may manipulate the user's device 10 to allow the execution of the SMS message of the device 10.

Additionally or alternatively, the notification may be carried out by activating the user's device 10 to present the incoming new message by opening the user's page presenting the new message along with the list of old messages or by presenting only the new message.

According to some embodiments of the present invention, the system may support “anonymous messaging”—which is receiving and sending messages under fabricated or anonymous identities. Since the system allows the messages to be sent by the distributor 120 rather than directly from the user's device 10—the system may allow users to register to the service or a separate service (such as, for example, a dating service) under any nickname defined by the user and/or under a confidential identity.

According to some embodiments of the present invention, once the user has entered the messaging service site (for, example, after receiving a notification regarding an anonymous message) through, for example, a WAP page, the user may be enabled to automatically contact the sender's or senders' mobile devices 10. For example, at least one of the services provided by the messaging services site may be a dating site where users may register to the site under nicknames (whereas the registered users' details may be stored in the database 200). Upon receiving a message from the dating service—the user may enter the dating site (using the user's device 10) where upon selecting the line where the new message is presented and, for example, one of the user's device's 10 buttons—the system may enable to initiate a call between the sender's device 11. (the one who sent the new message) and the user's device 10.

To enable the initiation of the call between the user and the sender's devices 10, 11 the distributor 120 may be a web server that allows retrieving the phone numbers of the user and the sender from a confidential phone book that may be stored in the database 200.

According to some embodiments of the present invention, the system may allow sending messages and notifications to groups of users' devices 10 according to predefined conditions in the system. For example, sending automatic “happy Holiday” messages, marketing messages, messages that contain information targeted to groups that have common interest in the same subject (according to the users' details saved in the database 200) etc.

According to some embodiments of the present invention, the system may be used for supporting Ecommerce activity and security. For example, the system may create and store users' profiles. Each user may be associated with a certain amount of “virtual coupons”—that are assigned to the user according to his/her profile, where the virtual coupons may be discount or money-worthy accounts to buy with in shops and vendors. The vendors and users may both use user's mobile devices 10 where each vendor may have an associated identification (ID) number. The user may send a message to the vendor, using the vendor's ID and receive in return a list of all available coupons and benefits, according to his/her profile. The same list may be sent to the vendor.

Additionally, the user may receive a partial picture or a partial barcode that may be used when a transaction is carried out. When the user decides to buy, he may confirm the purchase by clicking on ‘send’ or any other button of the user's device 10.

The vendor may be able then to see some of the user's details, for example, the user's picture (if available and/or if necessary), the partial barcode sent by the user or by the system, etc. The vendor may be able to see the complete list of coupons available to this user in his store using the messaging service site.

According to embodiments of the present invention, the system may enable the user to initiate a call from the user's device 10 to at least one destination that is presented at the messaging service site, by selecting the destination and activating an active link that may be attached to the message at the messaging service site to initiate the call. For example, initiating a confidential call to a sender's device 11. Once the user has entered the message sent by the sender at the messaging service site—by allowing the user to select the message. Upon connecting the user to the sender—the details of the sender may be confidential to the user and the details of the user may be confidential to the sender.

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention. Accordingly, the scope of the invention should not be limited by what has thus far been described, but by the appended claims and their legal equivalents.

What is claimed is:

1. A system to manage messages that are designated to a user's mobile communication device, using at least one internet messaging service site, said system comprising:
at least one database that comprises the users' personal messages, the messages' related information and the user's personal details;
a managing server, wherein said managing server enables identifying the arrival of a new message designated to said user, retrieving of the new message and the details of the designated user, wherein the designated user's details are retrieved from said database;
a distributor that enables notifying the user regarding the arrival of said new message, upon receiving the user's details from the managing server;
wherein upon identification of a new message the managing server sends the distributor the details of the designated user, and wherein the distributor initiates a call to the user's device to notify the user of said new message, using said user's details.

2. The system of claim 1 wherein said new message arrives from a sender's communication device.

3. The system of claim 1 wherein the managing server comprises a personal accounts manager that enables retrieving, storing, transmitting and presenting of the users' related data and messaging-data in personal accounts that are ascribed to the users.

4. The system of claim 1 wherein the distributor is an operator that notifies the user regarding at least one new message, by calling the user's device, using the user's device's phone number, extracted from the user's details, to initiate the call.

5. The system of claim 1 wherein the managing server enables inviting other new users to join the messaging service, once a veteran user sends a message to a new user unknown to the system, wherein the system automatically sends an invitation message to the new user's device allowing the new user to enter the messaging service site to register.

6. The system of claim 5 wherein the invitation message is sent as an SMS message.

7. The system of claim 6 wherein the invitation message comprises a link to the messaging service site to allow the new user to register, wherein the system automatically registers the new user to the messaging service once the user clicks on the link.

8. The system of claim 1 wherein the managing server enables automatically initiating a call to a sender's device—once the user has entered the message sent by the sender at the messaging service site by allowing the user to select a calling option in the message, wherein upon connecting the user to the sender the sender's phone number is confidential to the user and the user's phone number is confidential to the sender.

9. The system of claim 1 wherein the managing server enables the user to initiate a call from the user's device to the sender's device by allowing the user to select an active link attached to the message.

10. The system of claim 1 wherein the distributor call to the user's device may be identified by said device and stored under a name that is assigned to the identified number of the distributor.

11. The system of claim 1 wherein the distributor uses spoofing techniques in order to be identified by the user's device.

12. The system of claim 1 wherein the distributor's call to the user's device is identified by said device as a confidential number.

13. The system of claim 1 wherein the distributor is preset to ring the user's device for a preset time-interval, once a ringing tone is achieved.

14. The system of claim 1 wherein the messaging service site allows the user to select favorite accompanying services out of predefined available services, wherein said available services allow: setting the number of new messages that trigger the notification process; and setting availability parameters when the. user chooses to be available to receive notifications.

15. The system of claim 1 further enables the users to download and install a desktop client application on the user's personal computer (PC) that communicates with the managing server and the distributor, wherein said client application enables the user to contact the user's PC from the user's device.

16. The system of claim 15 wherein to connect and view information that is stored in said user's PC the user is required to enter the personal account in the messaging service site by entering a login name and a password.

17. The system of claim 1 wherein the distributor further enables sending a WAP push notification messages according to conditions predefined in the system.

18. The system of claim 1 further enables receiving and sending messages under a fabricated identity, wherein the distributor allows the sender to subscribe himself under a fabricated nickname.

19. The system of claim 1 wherein the messaging service site further enables creating and storing of users' profiles, wherein each user is associated with an amount of “virtual coupons”—that are assigned to the user according to the user's profile, wherein said coupons enable the user to receive benefits at vendors that are registered in the service.

20. A method to manage messages that are designated to a user's mobile communication device, using at least one internet messaging service; a managing server; at least one database; and a distributor; said method comprising the steps of:
receiving a message, and messaging-data - wherein the managing server receives a message and identifies the user to whom the new message is designated;
retrieving the user's details—wherein upon identifying the designated user—the managing server retrieves details of the user's device from the database and transmits said details to the distributor;
notifying the user regarding the arrival of at least one new message, wherein once the details of the user's device are received at the distributor—said distributor initiates a call to the user's device to notify the user regarding the arrival of said message;

21. The method of claim 20 further comprising the step of entering the messaging service site, wherein upon receiving the notification, the user is allowed to enter a messaging service site that contains the user's messages in a personal account to view the new message.

22. The method of claim 21, wherein to enter said personal account the user is required to enter a login name and a password, using the user's device.

23. The method of claim 20 wherein said notification of a the user is carried out by the distributor, and wherein said distributor calls the user's device upon receiving the user's details from the managing server.

24. A system to manage messages that are designated to a user's mobile communication device that comprises a polling application, using at least one internet messaging service, said system comprising:
at least one database that comprises the users' personal messages, the messages' related information and the user's personal details;
a managing server, wherein said managing server enables identifying the arrival of a new message designated to said user, retrieving of the new message and the details of the designated user, wherein the designated user's details are retrieved from said database; wherein the managing server manages the user's incoming messages and the polling application identifies a new message arriving to the managing server and executes a notification upon said identification.

25. The system of claim 24 wherein the managing server maintains a messaging service site and the polling application allows online connection to said site.

26. The system of claim 24 wherein said notification is carried out by activating the user's device to execute a ringing.

27. The system of claim 26 wherein said ring is followed by an SMS message.

28. The system of claim 24 wherein said notification is carried out by activating the user's device to present the incoming new message by opening the user's page and presenting the new message, wherein said new message is presented in the user's device.
